(19) United States
(12) Patent Application Publication
(10) Pub. No.: US 2007/0144263 A1
(43) Pub. Date: Jun. 28, 2007

(54) Apparatus for non-destructive evaluation of a workpiece including a uniform contact apparatus

(75) Inventors: Dong Fei, Peoria, IL (US); Jade M. Katinas, Chillicothe, IL (US); Leonard G. Wheat, Manito, IL (US); Todd M. Swanson, Alpha, IL (US); Douglas A. Rebinsky, Peoria, IL (US); Cliff J. Salisbury, Streator, IL (US); Jesus Guadalupe Chapa Cabrera, Monterrey (MX); James J. Streicher, Pontiac, IL (US)

Correspondence Address: Caterpillar Inc.;Intellectual Property Dept., AB 6490, 100 N.E. Adams Street, PEORIA, IL, 61629-6490, US

(73) Assignee: Caterpillar Inc.

(21) Appl. No.: 11/584,279

(22) Filed: Oct. 20, 2006

Related U.S. Application Data
(63) Continuation-in-part of application No. 11/319,025, filed on Dec. 27, 2005.

(51) Int. Cl. G01N 29/28; G01N 29/04

(52) U.S. Cl. 73/644; 73/866.5

(57) ABSTRACT

A workpiece internal flaw test apparatus has a frame that includes a workpiece support and a pair of transducer supports, a pair of transducers positioned on the transducer supports, a force generator, a signal generating and receiving device in communication with the pair of transducers, and a uniform contact apparatus. The pair of transducers are in alignment with one another and are adjacent opposite sides of the workpiece support. Each transducer has a contact face. The force generator is connected to the frame and is operable to push the pair of transducers toward each other with a predetermined force such that the contact faces of the transducers engage a test face of the workpiece. The uniform contact apparatus is positioned adjacent the contact face of each transducer such that the uniform contact apparatus is positionable to compensate for a misalignment between the transducer contact face and the test face of the workpiece and provide better sound coupling between the transducer and rough surface of the workpiece. A signal generating/receiving device is in communication with the transducers and provides the ability to analyze the test results to determine whether the workpiece has an internal flaw, such as a crack or void that would render it unsatisfactory for use.

### CROSS REFERENCE TO RELATED APPLICATIONS

This application is a continuation-in-part application of U.S. patent application Ser. No. 11/319,025, filed on Dec. 27, 2005, the benefit of priority from which is herein claimed, and the disclosures of which are incorporated herein by reference in their entirety.

### TECHNICAL FIELD

The present disclosure relates generally to detecting internal flaws, such as cracks, in workpieces, such as for example, engine exhaust particulate filters. The disclosure relates more particularly to an apparatus and method for non-destructive evaluation of these workpieces using ultrasonic techniques and including a device to create a uniform contact between an ultrasonic transducer and the workpiece for improved evaluation consistency.

### BACKGROUND

Increasingly stringent governmental regulations are reducing the permitted levels of undesirable emissions from internal combustion engines. Among these regulated emissions is particulate matter. In the case of diesel engines, many engine manufacturers are choosing to reduce particulate matter emissions through the use of particle traps. These particle traps typically take on a cylindrical shape with a honeycomb structure cross section. Generally, these honeycomb structures are formed by bringing a,powder of ceramic, metal or the like together with a binder, and extruding the mixture with a honeycomb shape. This structure is then fired to fix the honeycomb shape. In some instances, these filters may then be coated with a suitable catalyst to facilitate exhaust aftertreatment of other constituents, such as by the inclusion of a diesel oxidation catalyst for oxidizing hydrocarbons and carbon monoxide to carbon dioxide gas and other more desirable compounds. It is well known that, during the production process, occasional internal defects, such as cracks and internal voids, can sometimes occur in the honeycomb structures. When a crack occurs in cell walls of the honeycomb structure, the crack can significantly affect the durability of the trap and can result in a substantial deterioration in the ability of the filter to trap particles according expectations and specifications. Visual inspections have proven an inadequate strategy for detecting internal flaws in particulate filters.

It is known to employ an ultrasonic testing strategy to detect internal flaws in honeycomb structures. In one such strategy, a person holds an ultrasound transducer in each hand and presses them against opposite sides of the honeycomb structure. An ultrasonic through transmission test in a volume fraction of the filter is then performed. This test consists of generating an ultrasound signal in one of the transducers, transmitting the signal through the filter and receiving a resultant signal in the transducer on the opposite side. If the ultrasound signal is shown to be substantially attenuated at the opposite side, this could be an indication of an internal crack or void, based on the assumption that the ultrasound cannot bridge the gap represented by the crack or void. The person may perform this ultrasound through transmission test technique at several different locations through the particulate filter. While this ultrasound strategy can be useful in identifying some, and maybe a majority, of particulate filters with internal flaws, some flaws can go undetected or overlooked, and the filter can be misdiagnosed, due to many potential sources. Among these sources are inconsistent application of force, misalignment of the two transducers, defects in the transducer apparatus, changes that occur due to temperature, humidity and other factors, inconsistencies between filter structures due to wall thicknesses and plug lengths, and other variables known to those skilled in the art.

In another strategy for detecting cracks, U.S. Pat. No. 6,840,083 to Hijikata teaches a potentially destructive method for detecting an internal flaw. In this strategy, the particle trap is positioned in an upright orientation on top of a platform. An impact load is applied to the top of the trap. The particle trap is then moved, and any powdery substance that has dropped from the particle trap onto the platform is then analyzed to determine the location and magnitude of any internal flaws within the particle trap. Although this strategy may possibly be useful in detecting some internal flaws, it presents the risk of exacerbating and/or creating new cracks.

Non-destructive ultrasonic inspection of filters has been described in the '025 patent application. However, under certain conditions, there can be variability and inconsistencies in the measurements depending on the testing environment. In particular, instances that showed variability from test to test from misalignment or non-uniform contact between the transducers on the filter. It has also been found that commercially available transducers that use a stiff rubber membrane and liquid couplant in between the transducer and membrane do not have the ability to compensate for a misalignment between the transducer and the workpiece and have a lot of variations depending on how the couplant is filled.

The present disclosure is directed to overcoming one or more of the problems set forth above.

### SUMMARY OF THE DISCLOSURE

In one aspect, a workpiece internal flaw test apparatus having a frame that includes a workpiece support and a pair of transducer supports, a pair of transducers positioned on the transducer supports, a force generator, a signal generating and receiving device in communication with the pair of transducers, and a uniform contact apparatus is disclosed. The pair of transducers are in alignment with one another and are adjacent opposite sides of the workpiece support. Each transducer has a contact face. The force generator is connected to the frame and is operable to push the pair of transducers toward each other with a predetermined force such that the contact faces of the transducers engage a test face of the workpiece. The uniform contact apparatus is positioned adjacent the contact face of each transducer wherein the uniform contact apparatus is positionable to compensate for a misalignment between the transducer contact face and the test face of the workpiece.

In another aspect, a method of detecting an internal flaw in a workpiece is disclosed. The method includes the steps of providing a pair of transducers having a uniform contact apparatus attached thereto, positioning a workpiece in a test apparatus, positioning a contact face of the transducer against a test face of the workpiece, positioning the uniform contact apparatus to compensate for a misalignment between the contact face of the transducer and the test face of the workpiece, performing one of an ultrasound pulse echo test from a first side of the workpiece and an ultrasound through transmission test through the workpiece, and determining if at least one of tests indicate an internal flaw within the workpiece.

### BRIEF DESCRIPTION OF THE DRAWINGS

FIG. 1 is a schematic front view of a workpiece and test apparatus according to one aspect of the present disclosure.

FIG. 2 is a side schematic view of the workpiece and test apparatus of FIG. 1.

FIG. 3 is a perspective view of a portion of a transducer including a first embodiment of a uniform contact apparatus.

FIG. 4 is a schematic representation of the workpiece and transducer being operated during a test operation.

FIG. 5 is a schematic representation of the test operation of FIG. 4, with the uniform contact apparatus being implemented.

FIG. 6 is a perspective view of an alternate embodiment of a uniform contact apparatus.

FIG. 7 is a graphical representation of sample test results from the test apparatus showing transducer output as a function of transducer misalignment.

### DETAILED DESCRIPTION

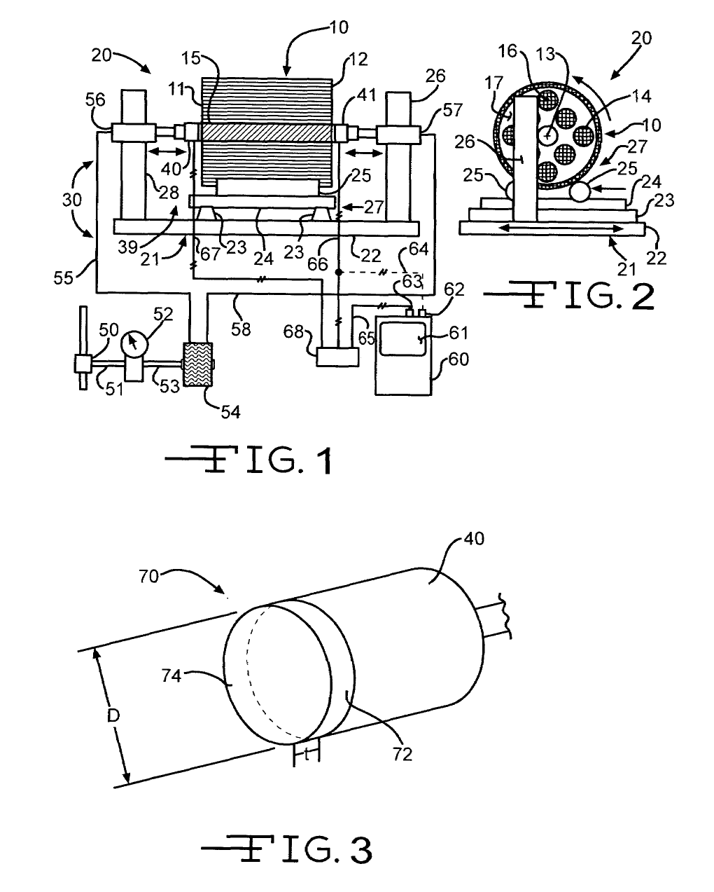

Referring initially to FIGS. 1 and 2, a workpiece 10 and an internal flaw test apparatus 20 are schematically shown with regard to one embodiment of the present disclosure. Operation of the test apparatus 20 includes the manual operation of the apparatus 20 to evaluate the workpiece. Although the embodiments described herein are discussed generally in the context of a diesel particulate filter, it can be appreciated that the apparatus and methods described herein are applicable to any workpiece 10 for its evaluation. The workpiece 10 includes a first side 11, a second side 12 and a centerline 13 extending between the sides. Each of the sides 11, 12 defines a test face 16 of the workpiece 10 upon which transducers can engage to conduct the ultrasound testing described herein. The workpiece 10 is shown with a template 17 attached to the test face 16 of the second side 12 as a means of guiding an operator of the test apparatus 20 in conducting a plurality of ultrasound tests through different volume fractions 15 of the workpiece 10 corresponding to the respective openings 14 in the template 17. The test apparatus 20 has a frame 21 that includes a workpiece support 27 including a roller mechanism 25, and a pair of transducer supports 26 and 28. A pair of ultrasonic transducers 40 and 41 are positioned on the transducer supports 28 and 26, respectively, and are adjacent opposite sides 11, 12 of the workpiece support roller mechanism 25. A force generator 30, which in the illustrated embodiment includes a pair of air cylinders 56 and 57 connected to the frame 21. The air cylinders 56, 57 are operable to push the pair of transducers 40, 41 toward each other with a predetermined force by being supplied with a uniform air pressure. The transducers 40, 41 may communicate with a signal generating/receiving device 60 via appropriate communication cables 64, 65, 66 and 67.

The test apparatus 20 includes a frame 21 having a base 22 upon which a pair of rails 23 are mounted. A platform 24 is moveably connected to the rails 23 such that the platform 24, and the roller mechanism 25 that it supports, can be moved to the left and right, as shown in FIG. 2, with regard to the transducer supports 26, 28. By locating the transducers 40, 41 at about the same level as the centerline 13 of the workpiece 10, the movement of the platform 24 can be adjusted to test any location across the diameter of the workpiece 10. Although the workpiece 10 is described as being generally cylindrical, it can be appreciated that the workpiece 10 can have any shape. A separate movement resistance feature (not shown) allows the platform 24 to be stopped and held at any desired location to the left and right as shown in FIG. 2. Thus, the combination of the movable platform 24 and the roller mechanism 25 mounted on the rails 23 can be thought of as a reconfiguring device 35 that is operable to reconfigure the relative position of the workpiece 10 with respect to the pair of transducers 40, 41. The roller mechanism 25 is operable to reconfigure the relative position of the workpiece 10 with regard to the pair of transducers 40, 41. This can be accomplished simply by rotating the workpiece 10 about its centerline 13 on the roller mechanism 25. Thus, by using the reconfiguring device 35 of the test apparatus 20, and by positioning the transducers 40, 41 at about the height of the workpiece centerline 13, the transducers 40, 41 can access any location across the sides 11 and 12 of the workpiece 10. In the illustrated embodiment, an operator would utilize the reconfiguring device 35 to test a plurality of volume fractions 15 of the workpiece 10 corresponding to the pattern of the openings 14 provided by the template 17 as shown in FIG. 2. The test locations represented by the template 17 as shown in FIG. 2 are equidistant from adjacent test locations, but can have any spacing or configuration.

The force generator 30 of the test apparatus 20 is illustrated as including a pair of air cylinders 56, 57 that have the pair of transducers 40, 41 mounted on couplers 45 and 46, respectively. Although it is not required, a bias mechanism, such as a spring, (not shown) may be included in the air cylinders 56, 57 to bias them away from the respective sides 11 and 12 of the workpiece 10 so that the transducers 40, 41 are normally out of contact with the workpiece 10 when air pressure is low in the air cylinders 56, 57. However, it is anticipated that in operation, the air-cylinder retracts through the four-way pedal. In the illustrated embodiment, the air cylinder 56 is connected to a manual valve 54 via a pressure supply line 55, and the air cylinder 57 is connected to the manual valve 54 via a second pressure supply line 58. The manual valve 54 is illustrated as being manually operated via a foot pedal that is available to the operator of the test apparatus 20, but could be any other suitable valve that is directly or indirectly controlled by some manual hand foot or other action on the part of the operator of the test apparatus 20. The manual valve 54 may also include a biasing mechanism to bias its position to normally keep pressure supply lines 55 and 58 closed to regulated pressure supply line 53. This would allow the air cylinders 56, 57 to only be pressurized when the foot pedal of the manual valve 54 is depressed. The regulated pressure supply line 53 is connected to a pressure source 50 via a high pressure line 51 and a pressure regulator 52. By appropriately adjusting the pressure regulator 52, a uniform pressure can be made in the pressure supply line 53, and hence the supply lines 55, 58 when the valve 54 is actuated. By utilizing a uniform pressure, a uniform and predetermined force can be generated to push the transducers 40, 41 toward one another in contact with the respective sides 11 and 12 of the workpiece 10.

Although the embodiment described above is illustrated via the use of air cylinders, those skilled in the art will appreciate that a wide variety of other actuators could be substituted without departing from the spirit and scope of the present disclosure. Among the potential substitutions are hydraulic cylinders, electric motors coupled to an appropriate worm gear or rack and pinion device, solenoids, or any other known actuator that can be used to push the transducers 40, 41 into contact with the test face 16 of the respective sides 11, 12 of the workpiece 10 with some predetermined and suitable force that allows for good transmission of ultrasound waves into the workpiece 10 while avoiding potential detrimental effects associated with using too much force.

The signal generating/receiving device 60 preferably includes a display 61 that can display a time trace of ultrasound magnitude that is received by either one of the transducers 40, 41. By utilizing a manual switch 68 and the various communication cables 64-67 with appropriate connectors (not shown), various different connections can be made to first and second ports 62 and 63 of the signal generating/receiving device 60 to perform an ultrasound through transmission test from the transducer 40 to the transducer 41, or vice versa, an ultrasound pulse echo test from the transducer 40, and an ultrasound pulse echo test associated with the transducer 41. For a pulse-echo test, the signal generating/receiving device 60 sends and receives a signal through the port 63. Thus, the switch 68 can be used to connect the transducer 40 to the port 63 through the cables 67 and 65 to perform a pulse-echo test on the first side 11 of the workpiece 10, or connect the transducer 41 to the port 63 through the cables 66 and 63 to perform a pulse-echo test on the second side 12 of the workpiece 10.

For a through-transmission test the signal generating/receiving device 60 can also be thought of as including an ultrasound transmission feature originating from one of the first and second ports 62 and 63. The other port is associated with an ultrasound receiving port that provides information for the display of a received ultrasound signal verses time on the display 61. For instance, if an ultrasound through transmission test were to be conducted using the transducer 40 as the transmitter and the transducer 41 as the receiver, the port 63 might be connected to the transducer 40 via the communication cable 65, the switch 68, and the communication cable 67. The transducer 41 would be connected to the port 62 on the signal generating/receiving device 60 via the communication cable 66 and the communication cable 64, which is shown as a dotted line to reflect the likely need to make various disconnections and reconnections in order to perform all of the different ultrasound tests on one volume fraction 15 of the workpiece 10. This embodiment of the present disclosure relies upon the operator to interpret the ultrasound magnitude data presented on display 61 in making a decision as to whether a crack exists in the specific volume fraction 15 of the workpiece 10 being tested with one of the ultrasound through transmission or pulse echo test available with appropriate connections.

As was described in the '025 patent application, many other variations of a test apparatus can be utilized to perform the functions of the test apparatus 20 described above. The other variations of a test apparatus described in the '025 application include a computer that is in communication with an electronic switch to operate the test apparatus 20. The computer may also receive and store data, conduct the testing, interpret the results of the ultrasound tests and display the evaluation on a monitor or display. Additionally, the computer can be programmed to cycle through multiple tests, automate the rotation or positioning of the workpiece 10, positioning of the transducers 40, 41, the movement and position of the platform 24, or can control and operate any other process, such as was described in the '025 application. In addition, a transducer array (not shown) can be used so that multiple tests can be conducted without changing the positions of the workpiece 10 or transducers 40, 41, and can also allow for simultaneous testing of multiple volume fractions 15. Thus, those skilled in the art will appreciate that any number of enhancements could be made to automate, increase data processing speed and accuracy and other considerations known in the art without departing from the present disclosure.

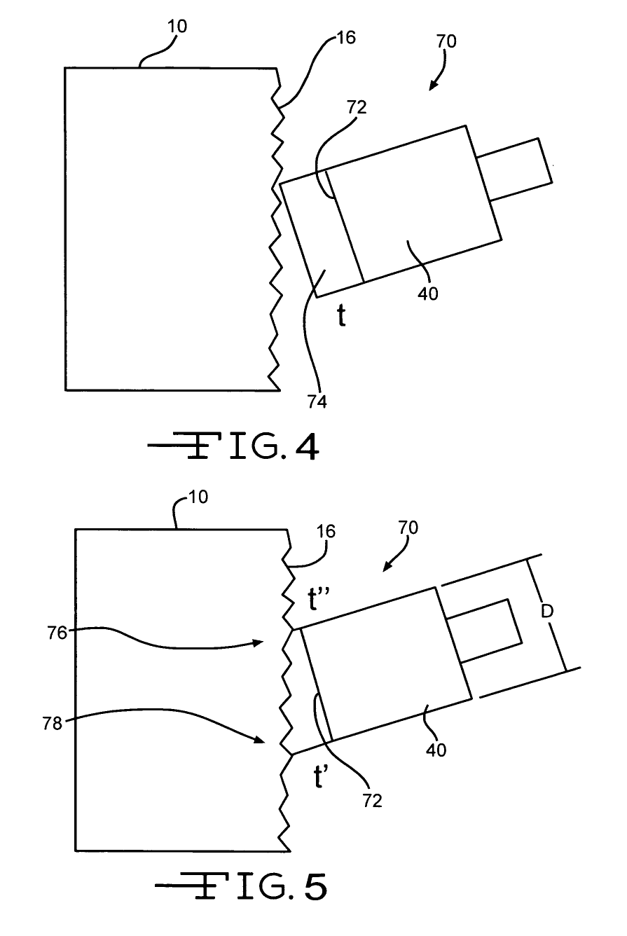

Referring now to FIG. 3, a perspective view of a first embodiment of the uniform contact apparatus, indicated generally at 70, is shown. The uniform contact apparatus 70 according to this embodiment includes an overlay 74 positioned adjacent to the first transducer 40. The overlay 74 in the illustrated embodiment is made of rubber, and more particularly made of a soft, thick, high strength silicone rubber. However, any material that is suitable for the purposes described herein can be used instead of rubber. As shown, the overlay 74 is sized and shaped to fit on the end of the transducer 40. In particular, the overlay 74 has substantially the same diameter, D, as the contact face 72 of the transducer 40. In additional, the overlay 74 has a thickness, t. A large thickness and a softer overlay 74 will give the uniform contact apparatus 70 a better ability of creating a uniform contact. A harder overlay 74 can also help create a better sound coupling between the transducer and rough surface workpiece 10. However, if the thickness is too large, it can affect the ultrasonic test signal. If the overlay 74 is too soft, it can lose the ability to recover to its original shape, affecting the durability of the overlay 74. The thickness, t, of the overlay 74 is a function of the type of transducer and type of testing that is to be performed. According to the present embodiment, the overlay 74 has the property of having a low attenuation of sound. Therefore, the overlay 74 does not substantially affect the test results of the ultrasound testing that is to be performed by the test apparatus 20 described above. The thickness of the overlay 74, under loading, also can either be much smaller than the wavelength or substantially equal to one-quarter (¼) the wavelength of the sound wave that is emitted by the transducer 40. One skilled in the art can appreciate that a quarter-wave tube, as one can consider the overlay 74, acts to minimize the loss of sound quality as the sound waves pass through the overlay 74. It can also be appreciated that the overlay 74 could enhance the output of the transducer 40 having a quarter wave thickness, t.

According to this embodiment, the overlay 74 is attached to the contact face 72 of the transducer 40 by a self-adhesive mechanism, and more particularly by a dry, self-adhesive mechanism. Such an attachment mechanism is useful so that a uniform signal is passed from the transducer 40, through the overlay 74 and into the workpiece 10. If a silicone adhesive, or other liquid adhesive, or other liquid couplant is used, the liquid may flow or be applied unevenly. Thus, the amount of adhesive or liquid couplant at a given location on the contact face 72 of the transducer 40 might be greater than the amount of adhesive at another location on the contact face 72. This could result in the attenuation, or disruption of the signal emitted from the transducer 40 and/or affect measurement consistency.

### INDUSTRIAL APPLICABILITY

The operation of the test apparatus 20, and of the alternate embodiments described in the '025 patent application is described in detail in that application. As such, a detailed recitation of those operations is not described herein. However, the disclosures of the '025 application are incorporated herein by reference in their entirety since the test apparatus 20 and the alternate embodiments described herein operate in a substantially similar manner to those of the '025 application with respect to the test apparatus 20. The additional features that are described herein are configurable to operate in conjunction with the embodiments described in the '025 application.

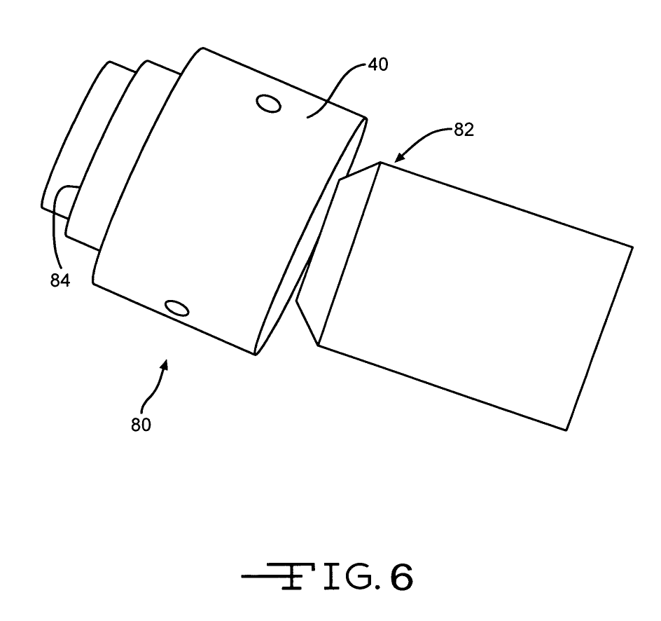

As shown in FIG. 4, the first transducer 40 is shown in a position just before engaging the test face 16 of the workpiece 10 during a testing operation using the test apparatus 20. As can be seen in FIG. 4, the transducer 40 is slightly misaligned relative to the test face 16 of the workpiece 10. It can be appreciated that the misalignment has been exaggerated for the purposes of the description herein. As the force generator device 30 is activated, the air cylinder 56 pushes the transducer 40 towards the workpiece 10. Without the uniform contact apparatus 70 described herein, the transducer 40 would remain misaligned. Under a misaligned condition, there could be variability and inconsistencies in the measurements received. In particular, instances that showed variability from test to test from misalignment or non-uniform contact between the transducers on the workpiece. In FIG. 4, the uniform contact apparatus 70 is positioned adjacent the contact face 72 of the transducer 40. However, since the transducer 40 has not contacted the test face 16 of the workpiece 10, the uniform contact apparatus 70 has not been positioned, or repositioned, as will be described next. Thus, the overlay 74 of the uniform contact apparatus 70 has its original, substantially uniform, thickness, t. As can also be seen in FIG. 4, the test face 16 of the workpiece 10 has a “rough” surface. While the workpiece 10 can have either a smooth or rough test face surface, it can be appreciated that the soft overlay 74 will be able to conform to the roughness of the test face 16 of the workpiece 10 should such a conformance be needed.

In FIG. 5, the force generator 30 has been further actuated to push the transducer 40 against the test face 16 of the workpiece 10. In this position, the overlay 74 has engaged the test face 16 of the workpiece 10. As can be seen, the overlay 74 of the uniform contact apparatus 70 has been positioned to compensate for the detected misalignment between the transducer 40 and the workpiece 10, as was shown in FIG. 4. As can also be seen, the thickness of the overlay 74 has changed across its diameter, D. To compensate for the misalignment shown in FIG. 4, the overlay 74 has been compressed at the upper and lower portion 76 of the overlay 74 to reduced thicknesses, t′ and t″. Because the misalignment between the transducer 40 and the workpiece 10 has been compensated for, the test results are more consistent. The soft overlay 74 also conforms to the rough surface of the workpiece 10 and thus provides better sound coupling between the transducer 40 and the workpiece 10. It can be appreciated that the compression, or repositioning, of the overlay 74 has been exaggerated to more clearly illustrate the application of the uniform contact apparatus 70 for the purposes described herein. Also, it can be appreciated that the overlay 74 will return to, or close to, its original shape and size when the test apparatus is returned to the standby position. It can also be appreciated that the uniform contact apparatus 70 can be used on both transducers 40, 41, and other mechanisms that require substantial alignment to perform the test operations with greater accuracy.

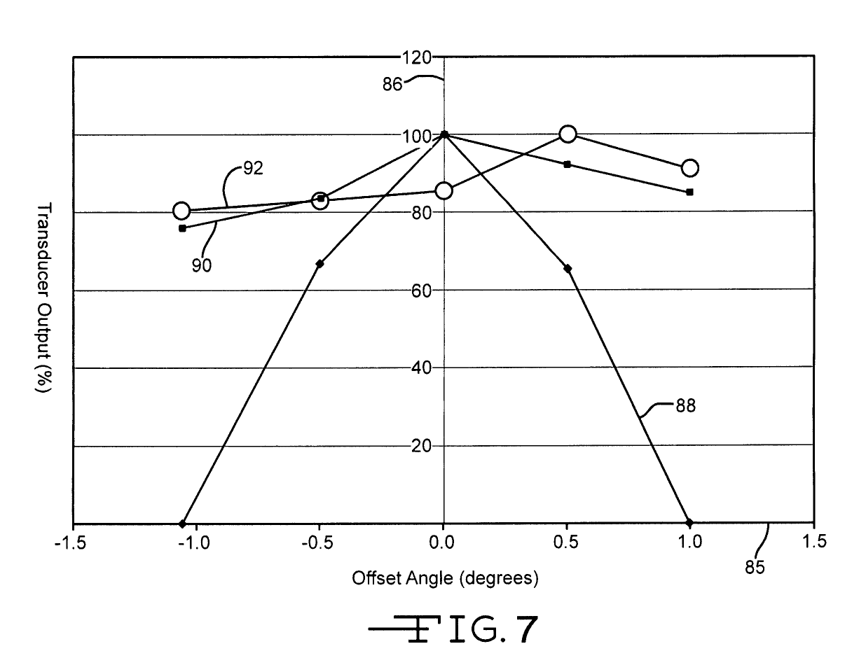

Illustrated in FIG. 6 is an alternate embodiment of a uniform contact apparatus. In FIG. 6, a uniform contact apparatus 80 including a gimbal mechanism 82 is shown. The uniform contact apparatus 80 is positioned adjacent the contact face 84 of the transducer 40 such that changing the position of the uniform contact apparatus 80 can change the position, orientation, or alignment of the transducer 40 with respect to the workpiece 10 (not shown in this Figure). The gimbal mechanism 82 is a mechanical device that allows the rotation of the transducer 40 in multiple dimensions. The gimbal mechanism 82 can include pivot means, such as two or three pairs of pivots that are mounted on axes at right angles. A three-axis gimbal may allow an object mounted on it to remain in a horizontal plane regardless of the motion of its support. As such, the transducer 40 can remain aligned with the workpiece 10 to ensure consistent and accurate results during a test operation using the test apparatus 20. It can also be appreciated that the uniform contact apparatus 80 (or 70), can be connected to a sensor (not shown) that can be implemented to determine a detected misalignment such that the sensor output sends a signal to a computer device that can operate the uniform contact apparatus 80 to correct the detected misalignment.

It can be appreciated that other mechanisms can be used as uniform contact apparatuses to accomplish the purposes described herein. In particular, a damper-spring assembly, an articulating joint, a ball joint assembly, a spherical bearing assembly, a computer controlled alignment means, an optical or laser guided system, or any combination of these uniform contact apparatuses can be used to correct for misalignments between a transducer and workpiece in a manner similar to the embodiments shown and described herein. However, the soft, relatively thick, and self-adhesive rubber overlay solution has many advantages such as low cost, simplicity, no increase of the overall transducer assembly side, ease of replacement, robustness, and low maintenance.

It can be appreciated that the term “adjacent” relative to the contact faces 72 of the transducers 40, 41 includes positioning the uniform contact apparatuses 70, 80, at any location near the transducers 40, 41 such that the position of the transducers 40, 41 can be changed by changing the position, orientation of the uniform contact apparatuses 70, 80.

Those skilled in the art will appreciate that some of the various features described with regard to FIG. 1 can be either automated or hastened in an enhanced test apparatuses. For instance, manual decision-making can be supplemented by computer decision-making, and also the need to possibly connect and reconnect different cables to perform all the tests could be eliminated. Alternate embodiments could allow for automated reconfiguring of the workpiece in the test apparatus rather than manually to further hasten the evaluation procedure. Another alternate embodiment could be used to hasten the evaluation procedure by having dedicated internal cards in the computer for more quickly gathering and analyzing data from the various ultrasounds through the transmission and pulse echo tests to be conducted. Another alternate embodiment can include multiple transducers (a transducer array) to conduct a plurality of tests nearly simultaneously without the need to reconfigure the workpiece for each different volume fraction to be tested. Nevertheless, some reconfiguring of the workpieces in the test apparatuses described herein may be necessary if transducer arrays do not cover the complete area to be tested. Finally, in another alternate embodiment, a test apparatus can further hasten the gathering of data from the transducer arrays through the use of dedicated pulse/receiving data acquisition cards.

Referring now to FIG. 7, a graphical example of a test result is illustrated to better show a variation that might occur during a test operation where one or more of the transducers 40, 41 are misaligned. The horizontal axis 85 represents the misalignment of the transducer 40 on a scale of degrees. The vertical axis 86 represents the effective transducer output on a scale of percentage output. In FIG. 7, the first line indicates a test result baseline 88, that is, a test operation conducted with a transducer 40 (or 41) not having a uniform contact apparatus 70 connected thereto. As can be seen, during the baseline test, the angular misalignment of the transducer 40 goes from −1.0 degrees to 0.0 degrees of misalignment and from 0.0 degrees to +1.0 degrees of misalignment. As can also be seen, at 0.0 degrees of misalignment, the transducer output of the baseline test 88 is about 100 percent. As the misalignment of the transducer 40 increases (in either direction ±1.0 degrees of misalignment), the transducer output decreases to 0 percent. The second line 90 and third line 92 indicate a second and third test result wherein the transducer 40 has a uniform contact apparatus 70 connected thereto. As can be seen, as the misalignment of the transducer increases (±), the transducer output is from about 80 percent (at −1.0 degrees) to 100 percent (at 0.0 degrees) to about 90 percent (at 1.0 degrees). Thus, only a total variation of about 20 percent occurs compared to the 100 percent variation that occurs when no uniform contact apparatus is used. Thus, the uniform contact apparatus 70 compensates for the misalignment of the transducer 40 and produces a better test result.

According to alternate embodiments of the test apparatus 20, in addition to those embodiments described in the '025 application, the test apparatus can be modified as described next. As seen in FIG. 1, the transducers 40, 41 and air cylinders 56, 57 are connected to the transducer supports 28 at about a mid-point of the supports 28. As a result, there is the potential that when a force is applied via the force generator 30, the transducers 40, 41 could rotate slightly around the “axis” of the transducer supports 28. Therefore, the transducers 40, 41 and air cylinders 56, 57 could be mounted at the top of the transducer supports 28 so thereby providing a more rigid support for the cylinders 56, 7 and the transducers 40, 41. It can be appreciated that other mechanisms on the test apparatuses can be modified so that the structure of the test apparatus is easier to reposition, easier to operate, is more structurally stable, or have other desirable characteristics.

It can also be appreciated that a method of operation of the test apparatus is also disclosed herein. In particular, the method of detecting an internal flaw in a workpiece includes the steps of providing a pair of transducers having a uniform contact apparatus attached thereto, positioning a workpiece in a test apparatus, positioning a contact face of the transducer against a test face of the workpiece, positioning the uniform contact apparatus to compensate for a misalignment between the contact face of the transducer and the test face of the workpiece, performing at least one of a first ultrasound pulse echo test from a first side of the workpiece and an ultrasound through transmission test through the workpiece, and determining if at least one of tests indicate an internal flaw within the workpiece. The method can also include the step of providing at least one reconfiguring device operable to reconfigure the position of at least one of the uniform contact apparatus, the workpiece, and the pair of transducers relative to each other. The method can also include the steps of providing a computer with a configuration control algorithm, the computer being in communication with the at least one reconfiguring device, detecting a misalignment between the contact face and the test face, and operating the reconfiguring device to re-position at least one of the workpiece and the pair of transducers relative to each other to compensate for the detected misalignment. The method can also include the step of performing both the second ultrasound pulse echo test in the workpiece from a second side, which is opposite the first side, and the ultrasound through transmission test, wherein the determining step includes a step of determining any of the three tests indicate an internal flaw within the workpiece. The method can also include the step of holding the transducer against the test face of the workpiece with a predetermined force, wherein the holding step includes pushing the transducer against a test face of the workpiece with a predetermined fluid pressure.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A workpiece internal flaw test apparatus comprising:
a frame that includes a workpiece support and a pair of transducer supports;
a pair of transducers positioned on the transducer supports in alignment with one another and adjacent opposite sides of the workpiece support, each transducer having a contact face;
a force generator connected to the frame and being operable to push the pair of transducers toward each other with a predetermined force such that the contact faces of the transducers engage a test face of the workpiece;
a signal generating and receiving device in communication with the pair of transducers; and
a uniform contact apparatus positioned adjacent the contact face of each transducer wherein the uniform contact apparatus is positionable to compensate for a misalignment between the transducer contact face and the test face of the workpiece.

2. The apparatus defined in claim 1 wherein the uniform contact apparatus includes an overlay attached to the contact face of the transducer.

3. The apparatus defined in claim 2 wherein the overlay is made from a rubber material.

4. The apparatus defined in claim 3 wherein the overlay is attached to the contact face by a dry self-adhesive mechanism.

5. The apparatus defined in claim 2 wherein the overlay has the property of having a low-attenuation of sound.

6. The apparatus defined in claim 2 wherein the overlay has a relative thickness that is smaller than the wavelength of the sound or substantially equal to one quarter of a wavelength of sound emitted by the transducers, when the overlay is under a load.

7. The apparatus defined in claim 1 wherein the uniform contact apparatus is one of a spherical bearing assembly, a damper-spring assembly, a ball joint assembly, and a gimbal mechanism.

8. The apparatus defined in claim 1 further including at least one reconfiguring device operable to reconfigure the position of the uniform contact apparatus to re-position at least one of the workpiece and the pair of transducers relative to each other.

9. The apparatus defined in claim 8 including a computer with a configuration control algorithm, the computer being in communication with the at least one reconfiguring device.

10. A method of detecting an internal flaw in a workpiece comprising the steps of:
providing a pair of transducers having a uniform contact apparatus attached thereto;
positioning a workpiece in a test apparatus;
positioning a contact face of the transducer against a test face of the workpiece;
positioning the uniform contact apparatus to compensate for a misalignment between the contact face of the transducer and the test face of the workpiece;
performing at least one of a first ultrasound pulse echo test from a first side of the workpiece and an ultrasound through transmission test through the workpiece; and
determining if at least one of tests indicate an internal flaw within the workpiece.

11. The method defined in claim 10 wherein the uniform contact apparatus is a rubber overlay.

12. The method defined in claim 11 wherein the overlay is attached to the contact face by a dry self-adhesive mechanism.

13. The method defined in claim 12 wherein the overlay has the property of having a low attenuation of sound.

14. The method defined in claim 11 wherein the overlay has a relative thickness that is smaller than the wavelength of the sound or substantially equal to one quarter of a wavelength of sound emitted by the transducers, when the overlay is under a load.

15. The method defined in claim 10 further including the step of providing at least one reconfiguring device operable to reconfigure the position of at least one of the uniform contact apparatus, the workpiece, and the pair of transducers relative to each other.

16. The method defined in claim 15 including the steps of:
providing a computer with a configuration control algorithm, the computer being in communication with the at least one reconfiguring device;
detecting a misalignment between the contact face and the test face; and
operating the reconfiguring device to re-position at least one of the workpiece and the pair of transducers relative to each other to compensate for the detected misalignment.

17. The method defined in claim 10 including the step of:
performing both the second ultrasound pulse echo test in the workpiece from a second side, which is opposite the first side, and the ultrasound through transmission test;
wherein the determining step includes a step of determining any of the three tests indicate an internal flaw within the workpiece.

18. The method defined in claim 17 wherein the performing steps are performed in a plurality of different volume fractions of the workpiece in a predetermined pattern.

19. The method defined in claim 10 including the step of holding the transducer against the test face of the workpiece with a predetermined force.

20. The method defined in claim 19 wherein the holding step includes pushing the transducer against a test face of the workpiece with a predetermined fluid pressure.
